(19) United States
(12) Patent Application Publication
(10) Pub. No.: US 2024/0062105 A1
(43) Pub. Date: Feb. 22, 2024

(54) INFORMATION PROCESSING APPARATUS, INFORMATION PROCESSING METHOD, AND RECORDING MEDIUM

(71) Applicant: NEC Corporation, Tokyo (JP)

(72) Inventors: Yuta Hatakeyama, Tokyo (JP); Yuzuru Okajima, Tokyo (JP)

(73) Assignee: NEC Corporation, Tokyo (JP)

(21) Appl. No.: 18/234,158

(22) Filed: Aug. 15, 2023

(30) Foreign Application Priority Data
Aug. 22, 2022 (JP) 2022-131688

(51) Int. Cl. G06N 20/00

(52) U.S. Cl. CPC G06N 20/00

(57) ABSTRACT

An information processing apparatus includes: a calculation unit that adds an index value indicating a degree of uncertainty of a prediction, to each of a plurality of instances, on the basis of the prediction for each of the plurality of instances respectively outputted from a plurality of learning models; a selection unit that selects at least one instance, of which the added index value is included in a predetermined selection range, from the plurality of instances; and an output unit that outputs the selected at least one instance.

### INCORPORATION BY REFERENCE

This application is based upon and claims the benefit of priority from Japanese Patent Application No. 2022-131688, filed on Aug. 22, 2022, the disclosure of which is incorporated herein in its entirety by reference.

### TECHNICAL FIELD

This disclosure relates to an information processing apparatus, an information processing method, and a recording medium.

### BACKGROUND ART

For example, there is proposed a technique/technology in which when degradation in accuracy of a learning model is detected, the learning model is re-learned to reduce the degradation in accuracy of the learning model (see Patent Literature 1). Furthermore, as prior art documents related to this disclosure, Patent Literatures 2 to 4 are cited.

### PRIOR ART DOCUMENTS

### Patent Literature

Patent Literature 1: International Publication No. WO2021/079442A1
Patent Literature 2: JP2019-079167A
Patent Literature 3: International Publication No. WO2017/145960A1
Patent Literature 4: JP2009-301557A

This disclosure aims at providing an information processing apparatus, an information processing method, and a recording medium that are configured to efficiently improve the accuracy of a learning model.

### SUMMARY

An information processing apparatus according to an example aspect of this disclosure includes: a calculation unit that adds an index value indicating a degree of uncertainty of a prediction, to each of a plurality of instances, on the basis of the prediction for each of the plurality of instances respectively outputted from a plurality of learning models; a selection unit that selects at least one instance, of which the added index value is included in a predetermined selection range, from the plurality of instances; and an output unit that outputs the selected at least one instance.

An information processing method according to an example aspect of this disclosure includes: adding an index value indicating a degree of uncertainty of a prediction, to each of a plurality of instances, on the basis of the prediction for each of the plurality of instances respectively outputted from a plurality of learning models; selecting at least one instance, of which the added index value is included in a predetermined selection range, from the plurality of instances; and outputting the selected at least one instance.

A recording medium according to an example aspect of this disclosure is a non-transitory recording medium on which a computer program that allows a computer to execute an information processing method is recorded, wherein the information processing method including: adding an index value indicating a degree of uncertainty of a prediction, to each of a plurality of instances, on the basis of the prediction for each of the plurality of instances respectively outputted from a plurality of learning models; selecting at least one instance, of which the added index value is included in a predetermined selection range, from the plurality of instances; and outputting the selected at least one instance.

### BRIEF DESCRIPTION OF THE DRAWINGS

FIG. 1 is a block diagram illustrating a configuration of an information processing apparatus according to a first example embodiment;

FIG. 2 is a block diagram illustrating a configuration of an information processing apparatus according to a second example embodiment;

FIG. 3 is a diagram illustrating an example of a distribution of index values added to data;

FIG. 4 is a flowchart illustrating operation of the information processing apparatus according to the second example embodiment;

FIG. 5 is a block diagram illustrating a configuration of an information processing apparatus according to a first modified example of the second example embodiment;

FIG. 6 is a block diagram illustrating a configuration of an information processing apparatus according to a second modified example of the second example embodiment;

FIG. 7 is a flowchart illustrating operation of the information processing apparatus according to the second modified example of the second example embodiment.

### EXAMPLE EMBODIMENTS

Hereinafter, an information processing apparatus, an information processing method, and a recording medium according to example embodiments will be described with reference to the drawings.

### First Example Embodiment

An information processing apparatus, an information processing method, and a recording medium according to a first example embodiment will be described with reference to FIG. 1. Hereinafter, the information processing apparatus, the information processing method, and the recording medium according to the first example embodiment will be described by using an information processing apparatus 1. FIG. 1 is a block diagram illustrating a configuration of the information processing apparatus 1.

Machine learning needs adding a correct answer label to each piece of a large amount of data, thereby generating learning data. As a method of reducing a burden on the generation of the learning data, active learning has been proposed. The “data” may be referred to as “instances”.

The active learning may be performed in the following procedure, for example. First, a learning model is generated by using a relatively small amount of learning data. Then, a plurality of pieces of data to which the correct answer label is not added, are inputted to the learning model. Then, on the basis of an output result of the learning model, at least one of data that are hard to predict by the learning model and data that are useful for improving the accuracy of the learning model are selected. Then, a response to the selected data (in other words, a correct answer) is inputted by a respondent. Then, the selected data with which the response inputted by the respondent is associated (in other words, annotated data), are added as learning data. After that, the added learning data are inputted to the learning model, by which the learning model is re-learned. In the active learning, the addition and re-learning of learning data may be repeated until a generalization performance of the learning model reaches a desired level. The respondent (that may be referred to as “oracle”) may be a human, or may be a determination or discrimination subject, such as a machine and a program, for example.

In the active learning, in order to efficiently advance the training of the learning model, it is preferable that data to be responded by the respondent (i.e., the data to which the correct answer label is not added) are properly selected. The information processing apparatus 1 includes a calculation unit 11, a selection unit 12, and an output unit 13, in order to select the data to be responded by the respondent, from the plurality of pieces of data to which the correct answer label is not added (see FIG. 1).

The calculation unit 11 obtains a prediction for each of the plurality of pieces of data respectively outputted from a plurality of learning models. The calculation unit 11 may obtain, for example, the prediction of one learning model for one piece of data, the prediction of the one learning model for another piece of data, the prediction of another learning model for the one piece of data, and the prediction of the other learning model for the other piece of data. Here, the “prediction” may mean an output of the learning model when one piece of data is inputted to the learning model. The learning model may be referred to as a prediction model.

The calculation unit 11 calculates an index value indicating a degree of uncertainty of the prediction, on the basis of the prediction for each of the plurality of pieces of data. The calculation unit 11 calculates the index value for each of the data. The calculation unit 11 may calculate the index value for one piece of data on the basis of the prediction for the one piece of data, and may calculate the index value for another piece o data on the basis of the prediction for the other piece of data, for example. The calculation unit 11 adds the calculated index value to the corresponding data. That is, the calculation unit 11 adds the index value to each of the plurality of pieces of data.

The selection unit 12 selects at least one piece of data, of which the added index value is included in a predetermined selection range, from the plurality of pieces of data. That is, the selection unit 12 selects at least one piece of data to be responded by the respondent, from the plurality of pieces of data. The output unit 13 outputs the selected at least one piece of data.

In the information processing apparatus 1, first, the calculation unit 11 adds the index value indicating the degree of uncertainty of the prediction, to each of the plurality of pieces of data, on the basis of the prediction for each of the plurality of pieces of data respectively outputted from the plurality of learning models. Then, the selection unit 12 selects at least one piece of data, of which the added index value is included in the predetermined selection range, from the plurality of pieces of data. Then, the output unit 13 outputs the selected at least one piece of data.

Such an information processing apparatus 1 may be realized or implemented, for example, by a computer reading a computer program recorded on a recording medium. In this case, it can be said that a computer program that allows a computer to execute a process is recorded on a recording medium, wherein the process including: adding an index value indicating a degree of uncertainty of a prediction, to each of a plurality of pieces of data, on the basis of the prediction for each of the plurality of pieces of data respectively outputted from a plurality of learning models; selecting at least one piece of data, of which the added index value is included in a predetermined selection range, from the plurality of pieces of data; and outputting the selected at least one piece of data.

The “degree of uncertainty of the prediction” may mean a degree of variation in a plurality of prediction results respectively outputted from the plurality of learning models, for one piece of data. As the plurality of prediction results become uniform, the degree of uncertainty of the prediction becomes smaller. In other words, as the plurality of prediction results become uneven, the degree of uncertainty of the prediction becomes larger. As the degree of uncertainty of the prediction becomes smaller, the index value may become smaller. In other words, as the degree of uncertainty of the prediction becomes larger, the index value may become larger.

One of the causes of an increase in the degree of uncertainty of the prediction is a relatively large amount of noise included in the data. The “noise” may mean unnecessary features included in the data. For example, in a binary problem of discriminating between positive and negative examples, when the learning model predicts the positive example, features that are different from those of the positive example included in the data are the noise. In this case, the features common to the positive and negative examples included in the data may be treated as the noise. In this case, if the features specific to the positive example included in the data are less than the other features, it can be said that the noise is relatively large. In other words, if the features specific to the positive example included in the data are greater than the other features, it can be said that the noise is relatively small.

Conventionally, as the data to be responded by respondent, data with the highest degree of uncertainty of the prediction (in other words, data including the largest amount of noise, of the plurality of pieces of data) are frequently selected. This is based on the idea that the accuracy of the learning model will be efficiently improved if the correct answer is taught to the learning model, from the data that are the hardest to predict by the learning model. Nonetheless, if the selected data are too biased, the accuracy of the learning model may be reduced by the re-learning using learning data based on the selected data.

In contrast, in the information processing apparatus 1, the selection unit 12 selects at least one piece of data, of which the added index value is included in the predetermined selection range, from the plurality of pieces of data. Therefore, for example, as compared with the instance where the data with the highest degree of uncertainty of the prediction are always selected, it is possible to prevent the bias of the data to be selected. Therefore, according to the first example embodiment, it is possible to efficiently improve the accuracy of the learning model.

In addition, the selection unit 12 may select two or more pieces of data of which the added index value is included in the predetermined selection range. For example, when only one piece of data is selected as the data to be responded by the respondent in one cycle of the active learning described above, only one piece of learning data is added in each cycle. In comparison with such a instance, if two or more pieces of data are selected by the selection unit 12, it is possible to increase the amount of learning data to be added in one cycle of the active learning. As a result, it can be expected that the accuracy of the learning model is efficiently improved.

The “predetermined selection range” may be a fixed range set in advance, or may be a variable range that varies depending on some parameter. The predetermined selection range may be set on the basis of the index value added to each of the plurality of pieces of data, for example. The predetermined selection range may be, for example, a range excluding a maximum value of the index value added to each of the plurality of pieces of data. The predetermined selection range may be, for example, a range including an index value that is less than the maximum value of the index value added to each of the plurality of pieces of data. The predetermined selection range may be a range including the maximum value of the index value added to each of the plurality of pieces of data.

The predetermined selection range may be, for example, a range excluding data with a relatively large degree of uncertainty of the prediction (in other words, data of which the added index value is relatively large). In addition, the predetermined selection range may be, for example, a range excluding data with a relatively small degree of uncertainty of the prediction (in other words, data of which the added index value is relatively small). On the other hand, the predetermined selection range may be, for example, a range including data with a moderate degree of uncertainty of the prediction. The “moderate degree of uncertainty of the prediction” may mean such a degree that one prediction result is relatively frequently outputted, but it is not frequently enough to consider that it converges on the one prediction result, even though there are differences in the plurality of prediction results respectively outputted from the plurality of learning models.

### Second Example Embodiment

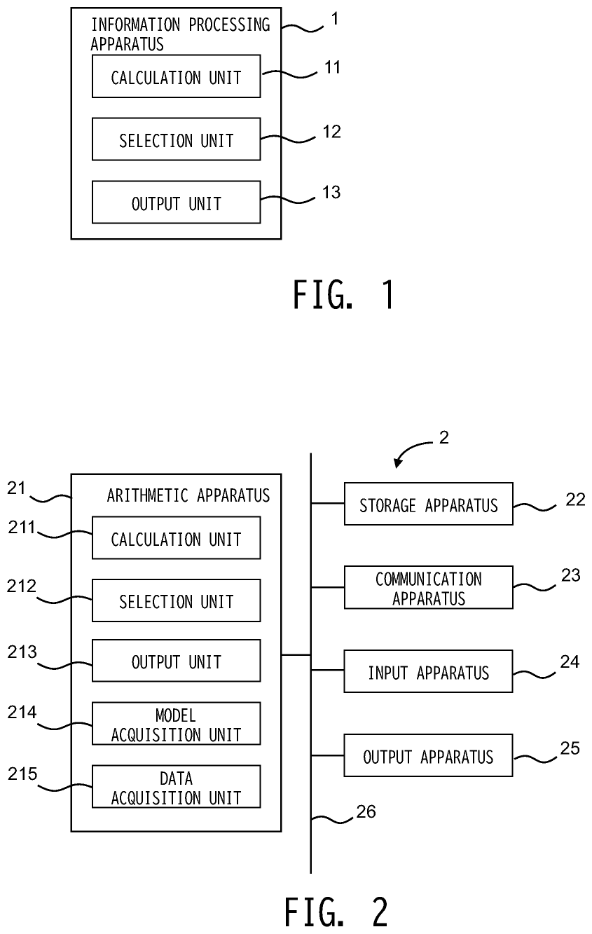

An information processing apparatus, an information processing method, and a recording medium according to a second example embodiment will be described with reference to FIG. 2 to FIG. 4. Hereinafter, the information processing apparatus, the information processing method, and the recording medium according to the second example embodiment will be described by using an information processing apparatus 2. FIG. 2 is a block diagram illustrating a configuration of the information processing apparatus 2.

As illustrated in FIG. 2, the information processing apparatus 2 includes an arithmetic apparatus 21 and a storage apparatus 22. The information processing apparatus 2 may include a communication apparatus 23, an input apparatus 24, and an output apparatus 25. The information processing apparatus 2 may not include at least one of the communication apparatus 23, the input apparatus 24, and the output apparatus 25. In the information processing apparatus 2, the arithmetic apparatus 21, the storage apparatus 22, the communication apparatus 23, the input apparatus 24, and the output apparatus 25 may be connected through a data bus 26.

The arithmetic apparatus 21 may include, for example, at least one of a CPU (Central Processing Unit), a GPU (Graphics Processing Unit), a FPGA (Field Programmable Gate Array), a TPU (Tensor Processing Unit), and a quantum processor.

The storage apparatus 22 may include, for example, at least one of a RAM (Random Access Memory), a ROM (Read Only Memory), a hard disk apparatus, a magneto-optical disk apparatus, and a SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program.

The communication apparatus 23 may be configured to communicate with an external apparatus of the information processing apparatus 2 through a not-illustrated communication network. The communication network may be a wide area network such as, for example, the Internet, or a narrow area network such as, for example, a LAN (Local Area Network). The communication apparatus 23 may perform a wired communication, or may perform a wireless communication.

The input apparatus 24 is an apparatus that is configured to receive an input of information to the information processing apparatus 2 from the outside. It may include an operating apparatus (e.g., a keyboard, a mouse, a touch panel, etc.) that is operable by an operator of the information processing apparatus 2. The input apparatus 24 may include a recording medium reading apparatus that is configured to read information recorded in a recording medium that is attachable to or detachable from the information processing apparatus 2, such as a USB (Universal Serial Bus) memory. When the information is inputted to the information processing apparatus 2 through the communication apparatus 23 (in other words, when the information processing apparatus 2 obtains the information through the communication apparatus 23), the communication apparatus 23 may function as an input apparatus.

The output apparatus 25 is an apparatus that is configured to output information to the outside of the information processing apparatus 2. As the above information, the output apparatus 25 may output visual information such as characters or images, may output auditory information such as a sound or a voice, or may output tactile information such as a vibration. The output apparatus 25 may include, for example, at least one of a display, a speaker, a printer, and a vibration motor. The output apparatus 25 may output the information to the recording medium that is attachable to or detachable from the information processing apparatus 2, such as, for example, a USB memory. When the information processing apparatus 2 outputs the information through the communication apparatus 23, the communication apparatus 23 may function as an output apparatus.

The arithmetic apparatus 21 may include a calculation unit 211, a selection unit 212, an output unit 213, a model acquisition unit 214, and a data acquisition unit 215, as functional blocks that are logically realized or implemented, or as processing circuits that are physically realized or implemented, for example. At least one of the calculation unit 211, the selection unit 212, the output unit 213, the model acquisition unit 214, and the data acquisition unit 215 may be realized or implemented by a combination of the logical functional blocks and the physical processing circuits (i.e., hardware). When at least a part of the calculation unit 211, the selection unit 212, the output unit 213, the model acquisition unit 214, and the data acquisition unit 215 is a functional block, the at least a part of the calculation unit 211, the selection unit 212, the output unit 213, the model acquisition unit 214, and the data acquisition unit 215 may be realized or implemented by the arithmetic apparatus 21 executing a predetermined computer program.

The arithmetic apparatus 21 may obtain (in other words, may read) the predetermined computer program, for example, from the storage apparatus 22. The arithmetic apparatus 21 may read the predetermined computer program stored by a computer-readable and non-transitory recording medium, by using a not-illustrated recording medium reading apparatus provided by the information processing apparatus 2, for example. The arithmetic apparatus 21 may obtain (in other words, may download or read) the predetermined computer program from a not-illustrated external apparatus of the information processing apparatus 2 through the communication apparatus 23. As the recording medium on which the predetermined computer program to be executed by the arithmetic apparatus 21 is recorded, at least one of an optical disk, a magnetic medium, a magneto-optical disk, a semi-conductor memory, and any other medium capable of storing a program may be used

The arithmetic apparatus 21 may perform the active learning, which is one of the learning techniques/technologies of machine learning. The arithmetic apparatus 21 may perform the active learning by “Query By Committee”, which is one technique/technology of the active learning.

The model acquisition unit 214 obtains a plurality of learning models that are-learned by the active learning. The model acquisition unit 214 may obtain one or more learning models from the storage apparatus 22, for example. The model acquisition unit 214 may obtain one or more learning models from an apparatus that is different from the information processing apparatus 2, for example, through the communication apparatus 23. The model acquisition unit 214 may obtain one or more learning models recorded in a recording medium, for example, through a recording medium reading apparatus that may be included in the input apparatus 24. The plurality of learning models obtained by the model acquisition unit 214 may have different structures or the same structure. Furthermore, learning progress of the plurality of learning models may be different or to the same extent.

The data acquisition unit 215 obtains a plurality of pieces of data to be used in the active learning. The plurality of pieces of data obtained by the data acquisition unit 215 include a plurality of pieces of data to which the correct answer label is not added. The plurality of pieces of data obtained by the data acquisition unit 215 may include a plurality of pieces of data to which the correct answer label is added. The data acquisition unit 215 may obtain one or more pieces of data from the storage apparatus 22, for example. The data acquisition unit 215 may obtain one or more pieces of data from an apparatus that is different from the information processing apparatus 2 through the communication apparatus 23, for example. The data acquisition unit 215 may obtain one or more pieces of data recorded in a recording medium, for example, through a recording medium reading apparatus that may be included in the input apparatus 24.

As one step of the active learning, the arithmetic apparatus 21 inputs the plurality of pieces of data to which the correct answer label is not added and which are obtained by the data acquisition unit 215, to each of the plurality of learning models obtained by the model acquisition unit 214. As a result, the prediction for each of the inputted pieces of data is outputted from the plurality of learning models.

The calculation unit 211 obtains the prediction for each of the pieces of data respectively outputted from the plurality of learning models. The calculation unit 211 calculates the index value indicating the degree of uncertainty of the prediction, on the basis of the prediction for each of the plurality of pieces of data. The calculation unit 211 adds the index value to each of the plurality of pieces of data to which the correct answer label is not added. The calculation unit 211 may calculate, for example, a Vote Entropy value (VE value), as the index value. The index value may be referred to as uncertainty.

The selection unit 212 selects at least one piece of data, of which the added index value is included in the predetermined selection range, from the plurality of pieces of data to which the correct answer label is not added. That is, the selection unit 212 selects at least one piece of data to be responded by the respondent, from the plurality of pieces of data. The output unit 213 outputs the selected at least one piece of data.

In this example embodiment, the respondent is assumed to be a human. The output 213 may transmit a signal indicating the selected at least one piece of data, to the output apparatus 25 including a display, for example. Consequently, at least one of characters and images indicating the selected at least one piece of data may be displayed.

When the respondent inputs the response through the input apparatus 24, as another step of the active learning, the arithmetic apparatus 21 adds the correct answer label based on the inputted response to the selected at least one piece of data, thereby generating learning data. The arithmetic apparatus 21 may store the generated learning data in the storage apparatus 22.

As another step of the active learning, the arithmetic apparatus 21 inputs the generated learning data to each of the plurality of learning models, thereby re-learning each of the plurality of learning models. After that, the arithmetic apparatus 21 may input the plurality of pieces of data to which the correct answer label is not added, to each of the plurality of learning models. That is, the arithmetic apparatus 21 may repeatedly perform a series of operation steps of the active learning described above.

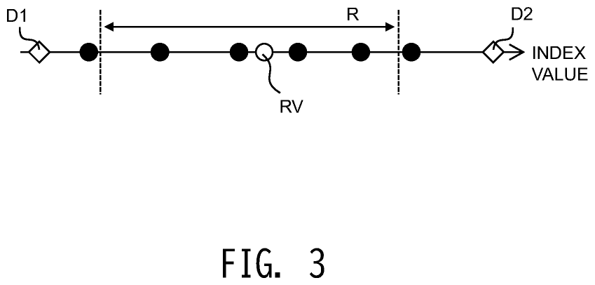

The selection of data by the selection unit 212 will be described with reference to FIG. 3. In FIG. 3, a horizontal axis represents the index value (e.g., the VE value). A rhombus D1 on a left side on the horizontal axis represents a minimum value that the index value can theoretically take. A rhombus D2 on a right side on the horizontal axis represents a maximum value that the index value can theoretically take. A plurality of black circles on the horizontal axis respectively represent a plurality of index values calculated by the calculation unit 211 (i.e., a plurality of index values respectively added to the plurality of pieces of data). As the index value calculated by the calculation unit 211 (i.e., the black circle in FIG. 3) approaches the rhombus D1, the degree of uncertainty of the prediction is reduced. As the index value calculated by the calculation unit 211 approaches the rhombus D2, the degree of uncertainty of the prediction is increased.

On the basis of the index values calculated by the calculation unit 211, for example, the selection unit 212 may set a range R that is less than the maximum value of the calculated index values, and that is greater than the minimum value of the calculated index values, as the predetermined selection range. The selection unit 212 may select at least one of the plurality of pieces of data to which the index values included in the range R are added. The range R that is the predetermined selection range may be set as a range including the maximum value of the calculated index values.

The selection unit 212 may set a reference value RV corresponding to one value included in the range R after setting the range R as the predetermined selection range. For example, the selection unit 212 may preferentially select, from the plurality of pieces of data to which the index values included in the range R are added, one piece of data to which the index value that is the closest to the reference value RV is added, in preference to other data. For example, when the selection unit 212 selects two pieces of data, the selection unit 212 may select, from the plurality of pieces of data to which the index values included in the range R are added, one piece of data to which the index value that is the closest to the reference value RV is added, and one piece of data to which the index value that is the second closest to the reference value RV is added. The selection unit 212 may set the reference value RV without setting the range R as the predetermined selection range. In this case, the selection unit 212 may set the reference value RV that is less than the maximum value that the index value can theoretically take, and that is greater than the minimum value that the index value can theoretically take, for example.

Alternatively, the selection unit 212 may select at least one of the plurality of pieces of data to which the index values included in the range R are added, in accordance with a probability that is inversely proportional to a difference between the reference value RV and the index value. In this case, while the one piece of data to which the index value that is the closest to the reference value RV is added is selected in preference to other data, one piece of data to which the index value that is relatively far from the reference value RV is added is sometimes selected. Therefore, it is possible to suitably prevent the bias of the data to be selected. When the difference between the reference value RV and the index value is “d”, the above probability may be expressed as “1/d”.

As described above, the selection unit 212 may select the data to be responded by the respondent by using at least one of the range R (i.e., the predetermined selection range) and the reference value RV. In this case, data with a relatively large degree of uncertainty of the prediction (in other words, data of which the added index value is relatively large), and data with a relatively small degree of uncertainty of the prediction (in other words, data of which the added index value is relatively small) are hardly selected. On the other hand, data with a moderate degree of uncertainty of the prediction (in other words, data of which the added index value is moderate) are easily selected.

The data of which the added index value is relatively large, may mean data of which the added index value is greater than a predetermined first threshold. The first threshold may be a fixed value, or may be a variable value that varies depending on some parameter. The first threshold may be set on the basis of the index value that is added to each of the plurality of pieces of data, for example. Furthermore, the data of which the added index value is relatively small, may mean data of which the added index value is less than a predetermined second threshold. The second threshold may be a fixed value, or may be a variable value that varies depending on some parameter. The second threshold may be set on the basis of the index value that is added to each of the plurality of pieces of data, for example. The second threshold may be typically less than the first threshold. Furthermore, the data of which the added index value is moderate, may mean data of which the added index value is less than a third threshold and that is greater than a fourth threshold. Each of the third and fourth thresholds may be a fixed value, or may be a variable value that varies depending on some parameter. Each of the third and fourth thresholds may be set on the basis of the index value that is added to each of the plurality of pieces of data, for example. The third threshold may be typically less than the first threshold, greater than the second threshold, and greater than the fourth threshold. The third threshold, however, may be the same as the first threshold. The fourth threshold may be typically less than the first threshold, greater than the second threshold, and greater than the third threshold. The fourth threshold, however, may be the same as the second threshold.

According to the study of the inventors, the following matters have been found. The accuracy of the learning model is more easily improved when the learning model is re-learned by using the learning data of which the correct answer label indicating the response of the respondent is added to the data with a moderate degree of uncertainty of the prediction, as compared to the instance where the learning model is re-learned by using the learning data of which the correct answer label indicating the response of the respondent is added to the data with the largest degree of uncertainty of the prediction, in the initial stage of the active learning. In the information processing apparatus 2, as described above, the data with a moderate degree of uncertainty of the prediction tend to be selected by the selection unit 212. Therefore, according to the second example embodiment, it is possible to efficiently improve the accuracy of the learning model.

The selection unit 212 may change the reference value RV in accordance with the progress of the active learning. For example, the selection unit 212 may change the reference value RV to a greater degree of uncertainty, as the active learn progresses. In this case, the predetermined selection range may be a range that is less than the maximum value that the index value can theoretically take and that is greater than the minimum value that the index value can theoretically take. The progress of the active learning may be determined on the basis of the number of pieces of the learning data added by the active learning, for example.

The arithmetic apparatus 21 may perform the active learning not only by “Query By Committee”, but also by one of the existing methods, such as “Uncertainly Sampling”, “Expected Model Change”, “Expected Error Reduction”, “Variance Reduction”, and “Density Weighted Methods”.

The calculation unit 211 may calculate, as the index value, not only the VE value, but also the index value related to “Least Confident”, “Margin Sampling”, “Entropy-based Approach” or the like, which are specific examples of “Uncertainly Sampling”, for example.

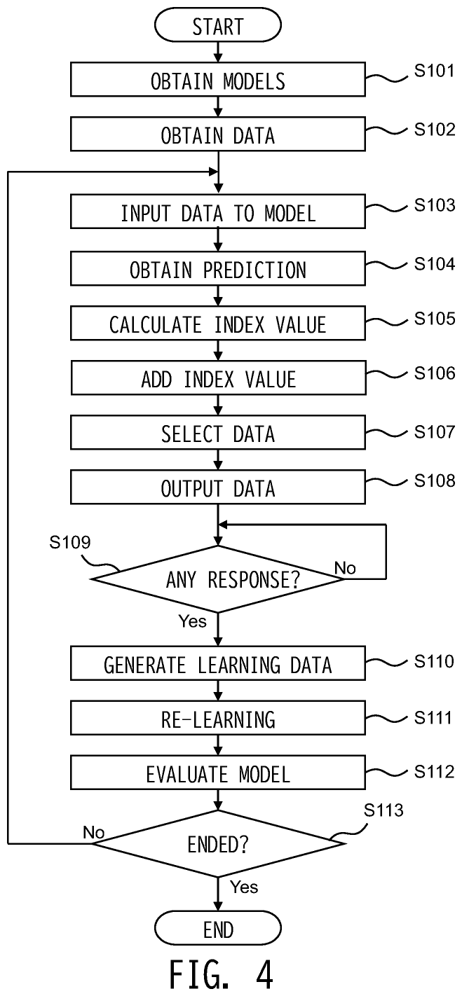

With reference to a flowchart in FIG. 4, the operation of the information processing apparatus 2 configured as described above will be described. In FIG. 4, the model acquisition unit 214 of the arithmetic apparatus 21 obtains the plurality of learning models that are-learned by the active learning (step S101). In parallel with the step S101, the data acquisition unit 215 of the arithmetic apparatus 21 obtains the plurality of pieces of data to be used in the active learning (step S102). In the step S102, the plurality of pieces of data to which the correct answer label is not added, are obtained. In the step S102, the plurality of pieces of data to which the correct answer label is added, may be obtained.

The arithmetic apparatus 21 inputs the plurality of pieces of data to which the correct answer label is not added, which are obtained in the S102, to each of the plurality of learning models obtained in the step S101 (step S103). The calculation unit 211 of the arithmetic apparatus 21 obtains the predictions for each of the plurality of pieces of data outputted from the plurality of learning models, as a result of the step S103 (step S104).

The calculation unit 211 calculates the index value indicating the degree of uncertainty of the prediction, on the basis of the prediction for each of the plurality of pieces of data (step S105). The calculation unit 211 adds the calculated index value to each of the plurality of pieces of data to which the correct answer label is not added (step S106). The selection unit 212 of the arithmetic apparatus 21 selects at least one piece of data, of which the added index value is included in the predetermined selection range, from the plurality of pieces of data to which the correct answer label is not added (step S107).

The output unit 213 of the arithmetic apparatus 21 outputs the at least one piece of data selected in the step S107 (step S108). In the step S108, the output unit 213 may transmit the signal indicating the selected at least one piece of data, to the output apparatus 25 including a display, for example. Consequently, at least one of characters and images indicating the selected at least one piece of data may be displayed.

Then, the arithmetic apparatus 21 determines whether or not the response is inputted (step S109). In the step S109, when it is determined that the response is not inputted (step S109: No), the step S109 is performed. That is, the arithmetic apparatus 21 may be in a standby state until the response is inputted.

In the step S109, when it is determined that the response is inputted (step S109: Yes), the arithmetic apparatus 21 adds the correct answer label based on the inputted response, to the at least one piece of data selected in the step S107, thereby generating the learning data (step S110). Then, the arithmetic apparatus 21 inputs the generated learning data to each of the plurality of learning models, thereby re-learning each of the plurality of learning models (step S111).

Then, the arithmetic apparatus 21 evaluates each of the plurality of learning models (step S112). Each of the plurality of learning models may be evaluated on the basis of an accuracy rate (accuracy), for example. Then, the arithmetic apparatus 21 determines whether or not a predetermined end condition is satisfied on eh basis of a result of the step S112 (step S113).

In the step S113, when it is determined that the predetermined end condition is satisfied (step S113: Yes), the operation illustrated in FIG. 4 is ended. On the other hand, in the step S113, when it is determined that the predetermined end condition is not satisfied (step S113: No), the step S103 is performed.

The above operation may be realized by the information processing apparatus 2 reading a computer program recorded on a recording medium. In this case, it can be said that the computer program for allowing the information processing apparatus 2 to execute the above operation is recorded on the recording medium. The arithmetic apparatus 21 of the information processing apparatus 2 may correspond to the information processing apparatus 1 according to the first example embodiment.

### First Modified Example

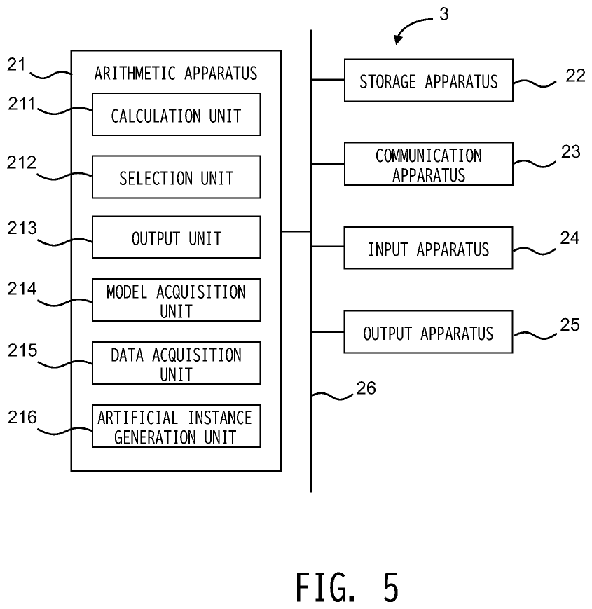

An information processing apparatus, an information processing method, and a recording medium according to a first modified example of the second example embodiment will be described with reference to FIG. 5. In FIG. 5, the arithmetic apparatus 21 of an information processing apparatus 3 may include an artificial instance generation unit 216. The artificial instance generation unit 216 may be, for example, a functional block that is logically realized or implemented, or a processing circuit that is physically realized or implemented. Alternatively, the artificial instance generation unit 216 may be realized or implemented in a form in which the logical functional block is mixed with the physical processing circuit (i.e., hardware). When at least a part of the artificial instance generation unit 216 is a functional block, the at least a part of the artificial instance generation unit 216 may be realized or implemented by the arithmetic apparatus 21 executing a predetermined computer program.

The data acquisition unit 215 of the arithmetic apparatus 21 may obtain a plurality of pieces of actual data, as the plurality of pieces of data to which the correct answer label is not added. The artificial instance generation unit 216 may generate a plurality of pieces of artificial data, on the basis of at least a part of the plurality of actual data. The plurality of pieces of artificial data generated by the artificial instance generation unit 216 may be inputted to each of the plurality of learning models, as the plurality of pieces of data to which the correct answer label is not added.

After the step S102 and before the step S103, the artificial instance generation unit 216 may generate the plurality of artificial data, on the basis of at least a part of the plurality of actual data obtained in the step S102 (i.e., the plurality of pieces of actual data to which correct answer label is not added). Since the existing various aspects can be applied to a method of generating the artificial data, a description of the details of the method of generating the artificial data will be omitted.

With this configuration, it is possible to perform the active learning without collecting a large amount of actual data. In addition, it is possible to reduce a cost required for data collection, for example. The “actual data” and the “artificial data” may be referred to as “actual instances” and “artificial instances”, respectively.

By the way, if the actual data used by the artificial instance generation unit 216 to generate the artificial data include a relatively large amount of noise, the generated artificial data may also include a relatively large amount of noise. That is, in this case, there is a possibility that the data that are hard to predict by the learning model are generated by the artificial instance generation unit 216. Even in this case, if the selection unit 212 selects the data to be responded by the respondent as described above, it is possible to prevent that the artificial data including a relatively large amount of noise are selected. Therefore, according to the first modified example, it is possible to efficiently improve the accuracy of the learning model.

### Second Modified Example

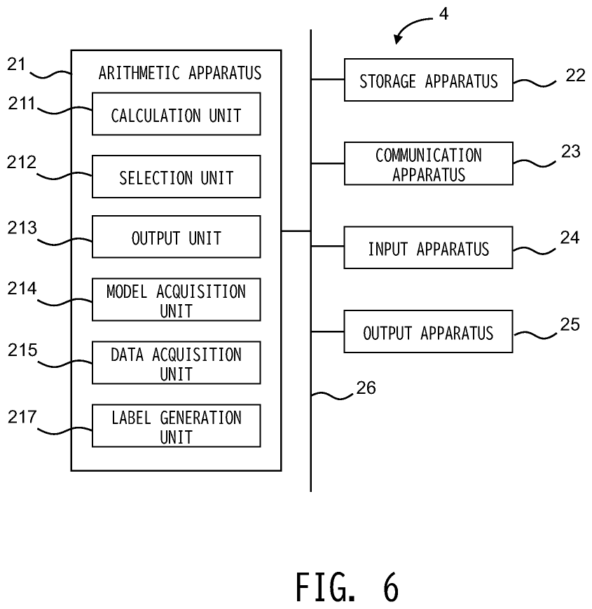

An information processing apparatus, an information processing method, and a recording medium according to a second modified example of the second example embodiment will be described with reference to FIG. 6. In FIG. 6, the arithmetic apparatus 21 of an information processing apparatus 4 may include a label generation unit 217. The label generation unit 217 may be, for example, a functional block that is logically realized or implemented, or a processing circuit that is physically realized or implemented. Alternatively, the label generation unit 217 may be realized implemented in a form in which the logical functional block is mixed with the physical processing circuit (i.e., hardware). When at least a part of the label generation unit 217 is a functional block, the at least a part of the label generation unit 217 may be realized or implemented by the arithmetic apparatus 21 executing a predetermined computer program.

The label generation unit 217 of the arithmetic apparatus 21 may obtain the response to the at least one piece of data, by inputting the at least one piece of data selected by the selection unit 212 to the learning model that is the respondent. The label generation unit 217 may add the correct answer label based on the obtained response to the selected at least one piece of data, thereby generating the learning data. In this instance, the output unit 213 may output the generated learning data (in other words, at least one piece of data to which the correct answer label is added). For example, the output unit 213 may store the at least one piece of data to which the correct answer label is added, in the storage apparatus 22.

Here, the learning model that is the respondent is a learning model that is trained more than the plurality of learning models that are-learned by the active learning. The learning model that is the respondent may be a model with a more complex structure than those of the plurality of learning models that are-learned by the active learning. Specifically, the learning model that is the respondent may be a learning model using a deep neural network, for example. Each of the plurality of learning models that are-learned by the active learning may be a learning model using a decision tree, for example. Alternatively, the learning model may be a piecewise linear model utilizing random forest, support vector machine, naive bayes, or Factorized Asymptotic Bayesian Inference (FAB). A technique/technology of the piecewise linear modeling using FAB is disclosed in U.S. Publication No. US2014/0222741A1 or the like, for example.

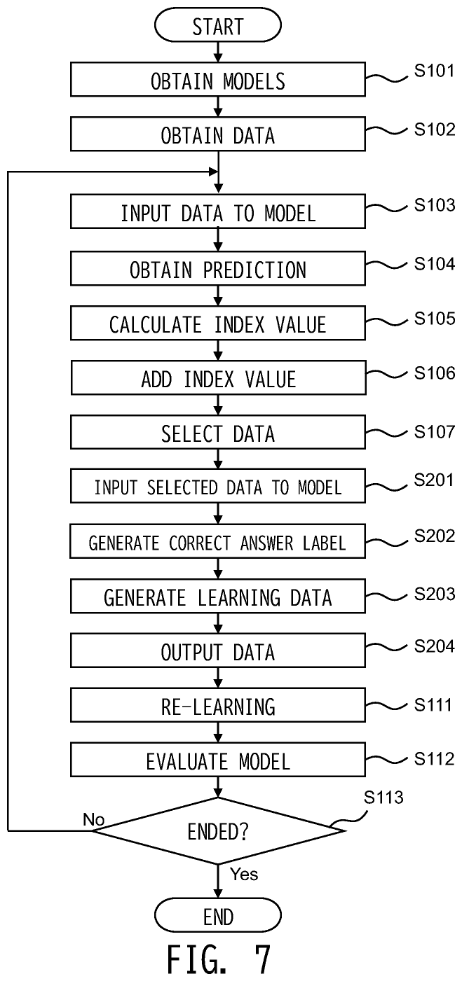

With reference to a flowchart in FIG. 7, the operation of the information processing apparatus 4 configured as described above will be described. In FIG. 7, after the step S107, the label generation unit 217 may input the at least one piece of data selected in the step S107 to the learning model that is the respondent (step S201). The label generation unit 217 may generate the correct answer label, on the basis of the response to the selected at least one piece of data outputted from the learning model that is the respondent (step S202). The label generation unit 217 adds the correct answer label generated in the step S202 to the at least one piece of data selected in the step S107, thereby generating the learning data (step S203). The output unit 213 may output the generated learning data (S204).

According to the second modified example, there is no need for a human to input the response to the data selected by the selection unit 212. Therefore, it is possible to save manpower for the active learning.

With respect to the example embodiments described above, the following Supplementary Notes will be further described.

### (Supplementary Note 1)

An information processing apparatus including:
a calculation unit that adds an index value indicating a degree of uncertainty of a prediction, to each of a plurality of instances, on the basis of the prediction for each of the plurality of instances respectively outputted from a plurality of learning models;
a selection unit that selects at least one instance, of which the added index value is included in a predetermined selection range, from the plurality of instances; and
an output unit that outputs the selected at least one instance.

### (Supplementary Note 2)

The information processing apparatus according to Supplementary Note 1, wherein the predetermined selection range is a range that is less than a maximum value of the index value and that is greater than a minimum value of the index value.

### (Supplementary Note 3)

The information processing apparatus according to Supplementary Note 1, wherein the predetermined selection range is a range that does not include a maximum value of the index value.

### (Supplementary Note 4)

The information processing apparatus according to Supplementary Note 1, wherein the predetermined selection range is a range that includes an index value that is less than a maximum value of the index value.

### (Supplementary Note 5)

The information processing apparatus according to any one of Supplementary Notes 1 to 4, wherein the selection unit selects, as the at least one instance, at least one instance that is different from a instance of which a maximum value of the index value is added.

### (Supplementary Note 6)

The information processing apparatus according to any one of Supplementary Notes 1 to 5, wherein the selection unit selects the at least one instance from the plurality of instances, on the basis of a reference value corresponding to one value included in the predetermined selection range and the index value added to each of the plurality of instances.

### (Supplementary Note 7)

The information processing apparatus according to Supplementary Note 6, wherein the selection unit selects a instance of which a difference between the reference value and the index value added to each of the plurality of instances is the smallest.

### (Supplementary Note 8)

The information processing apparatus according to Supplementary Note 6, wherein the selection unit selects the at least one instance from the plurality of instances in accordance with a probability that is inversely proportional to a difference between the reference value and the index value added to each of the plurality of instances.

### (Supplementary Note 9)

The information processing apparatus according to any one of Supplementary Notes 1 to 8, wherein the information processing apparatus includes a label generation unit that generates a label associated with the selected at least one instance and that adds the generated label to the selected at least one instance, and the output unit outputs at least one instance to which the generated label is added.

### (Supplementary Note 10)

The information processing apparatus according to any one of Supplementary Notes 1 to 9, wherein
the information processing apparatus includes a instance generation unit that generates a plurality of artificial instances from at least one actual instance, and
the plurality of instances include the generated plurality of artificial instances.

### (Supplementary Note 11)

An information processing apparatus including:
a calculation unit that adds an index value indicating a degree of uncertainty of a prediction, to each of a plurality of instances, on the basis of the prediction for each of the plurality of instances respectively outputted from a plurality of learning models;
a selection unit that selects at least one instance from the plurality of instances, on the basis of a reference value that is less than a maximum value of the index value, and the index value added to each of the plurality of instances; and
an output unit that outputs the selected at least one instance.

### (Supplementary Note 12)

An information processing apparatus including:
a selection unit that selects at least one instance, of which a degree of uncertainty of a prediction is moderate, from a plurality of instances, on the basis of the predictions for each of the plurality of instances respectively outputted from a plurality of learning models; and
an output unit that outputs the selected at least one instance.

### (Supplementary Note 13)

A non-transitory recording medium on which a computer program that allows a computer to execute an information processing method is recorded, wherein the information processing method including:
adding an index value indicating a degree of uncertainty of a prediction, to each of a plurality of instances, on the basis of the prediction for each of the plurality of instances respectively outputted from a plurality of learning models;
selecting at least one instance, of which the added index value is included in a predetermined selection range, from the plurality of instances; and
outputting the selected at least one instance.

This disclosure is not limited to the above-described examples and is allowed to be changed, if desired, without departing from the essence or spirit of the invention which can be read from the claims and the entire specification. An information processing apparatus, an information processing method, and a recording medium with such changes, are also included in the technical concepts of this disclosure.

### DESCRIPTION OF REFERENCE NUMERALS

1, 2, 3, 4 . . . Information processing apparatus, 11, 211 . . . Calculation unit, 12, 212 . . . Selection unit, 13, 213 . . . Output unit, 21 . . . Arithmetic apparatus, 22 . . . Storage apparatus, 23 . . . Communication apparatus, 24 . . . Input apparatus, 25 . . . Output apparatus, 214 . . . Model acquisition unit, 215 . . . Data acquisition unit, 216 . . . Artificial instance generation unit, 217 . . . Label generation unit

What is claimed is:

1. An information processing apparatus comprising:
a calculation unit that adds an index value indicating a degree of uncertainty of a prediction, to each of a plurality of instances, on the basis of the prediction for each of the plurality of instances respectively outputted from a plurality of learning models;
a selection unit that selects at least one instance, of which the added index value is included in a predetermined selection range, from the plurality of instances; and
an output unit that outputs the selected at least one instance.

2. The information processing apparatus according to claim 1, wherein the predetermined selection range is a range that is less than a maximum value of the index value and that is greater than a minimum value of the index value.

3. The information processing apparatus according to claim 1, wherein the selection unit selects the at least one instance from the plurality of instances, on the basis of a reference value corresponding to one value included in the predetermined selection range and the index value added to each of the plurality of instances.

4. The information processing apparatus according to claim 3, wherein the selection unit selects a instance, of which a difference between the reference value and the index value added to each of the plurality of instances, is the smallest.

5. The information processing apparatus according to claim 3, wherein the selection unit selects the at least one instance from the plurality of instances in accordance with a probability that is inversely proportional to a difference between the reference value and the index value added to each of the plurality of instances.

6. The information processing apparatus according to claim 1, wherein,
the information processing apparatus comprises a label generation unit that generates a label associated with the selected at least one instance and that adds the generated label to the selected at least one instance, and
the output unit outputs at least one instance to which the generated label is added.

7. The information processing apparatus according to claim 1, wherein,
the information processing apparatus comprises a instance generation unit that generates a plurality of artificial instances from at least one actual instance, and
the plurality of instances include the generated plurality of artificial instances.

8. An information processing method comprising:
adding an index value indicating a degree of uncertainty of a prediction, to each of a plurality of instances, on the basis of the prediction for each of the plurality of instances respectively outputted from a plurality of learning models;
selecting at least one instance, of which the added index value is included in a predetermined selection range, from the plurality of instances; and
outputting the selected at least one instance.

9. A non-transitory recording medium on which a computer program that allows a computer to execute an information processing method is recorded, wherein the information processing method including:
adding an index value indicating a degree of uncertainty of a prediction, to each of a plurality of instances, on the basis of the prediction for each of the plurality of instances respectively outputted from a plurality of learning models;
selecting at least one instance, of which the added index value is included in a predetermined selection range, from the plurality of instances; and
outputting the selected at least one instance.
